(19) United States
(12) Patent Application Publication
(10) Pub. No.: US 2017/0006855 A1
(43) Pub. Date: Jan. 12, 2017

(54) Mount for Hunting Decoy

(71) Applicant: Paul Wessel, Delano, MN (US)

(72) Inventor: Paul Wessel, Delano, MN (US)

(21) Appl. No.: 14/795,357

(22) Filed: Jul. 9, 2015

(51) Int. Cl. A01M 31/06

(52) U.S. Cl. CPC A01M 31/06

(57) ABSTRACT

A decoy mount includes a base, a spring member, attached to the base, an insert member attached to the spring member, and an adjustable rod that is slidable within the insert member. A decoy is attached to the slidable rod. Adjustment of the slidable rod permits a user to tune the decoy mount so that it is life-like in a variety of wind conditions.

### CROSS-REFERENCE TO RELATED APPLICATIONS

None.

### BACKGROUND

Hunting for migratory waterfowl is a long-held tradition in many places around the world, including the United States; for the past decade, however, sales of U.S. Federal Duck Stamps have indicated a steady decline in the number of waterfowl hunters. While the number of waterfowl hunters has declined, waterfowl populations, especially Canada and Snow Goose populations, have exploded and begun to take an environmental toll on breeding areas. If left unchecked, these populations pose an eminent threat to themselves and the environment.

To pare down populations, many states, whose agricultural areas have been afflicted by large goose populations, have offered bonus seasons and liberal kill limits. Overall, these changes have proven at least somewhat ineffective. One of the latest strategies to manage populations is through spring hunting seasons. Additionally, recently approved electronic calling systems, to entice migrating geese into a decoy spread, have helped, but only minimally.

When attempting to decoy large flocks of geese, waterfowl hunters face additional challenges of having thousands of skeptical eyes viewing the same area looking for any suspicious anomaly. One of the major goals of the goose hunter is to set up a decoy spread that reflects the most natural setting, including using decoys that move.

A particularly difficult hunting situation involves a “no wind” condition. Waterfowl land into the wind and if no wind is present it makes the task of landing more difficult, reducing the likelihood that waterfowl will land at the no wind location. Another major problem presented by is a lack of movement with existing decoys, which rely on wind to generate movement. Without movement in the decoy spread, waterfowl are less likely to be drawn to the decoys.

To combat problems associated with no wind conditions, several battery-operated, mechanically driven, decoys have been developed. Yet this solution has its drawbacks; for example, battery power tends to be clumsy and heavy in hunting conditions. Additionally, rechargeable batteries are often employed, requiring hunters to regularly recharge their power source.

In light of the foregoing, there remains a need for a decoy system that does not rely on a battery power source and is able to function in no wind, slight wind, or even substantial wind situations.

The art referred to and/or described above is not intended to constitute an admission that any patent, publication or other information referred to herein is “prior art” with respect to this invention. In addition, this section should not be construed to mean that a search has been made or that no other pertinent information as defined in 37 C.F.R. §1.56(a) exists.

All US patents and applications and all other published documents mentioned anywhere in this application are incorporated herein by reference in their entirety.

Without limiting the scope of the invention a brief summary of some of the claimed embodiments of the invention is set forth below. Additional details of the summarized embodiments of the invention and/or additional embodiments of the invention may be found in the Detailed Description of the Invention below.

### SUMMARY

In some embodiments, a decoy mount includes a base, a spring member, an adjustable rod, a spring insert, and a decoy. The spring member is attached to the base and the spring insert is coupled to the spring member. The adjustable rod is slidable within the spring insert, wherein the decoy is attached to an end of the adjustable rod.

In some embodiments, a decoy mount includes a base, a spring member attached to the base, an adjustable rod, and a decoy attached to the adjustable rod. The adjustable rod is longitudinally adjustable with respect to the spring member and the spring member comprises a coil spring.

In some embodiments, a decoy mount kit includes a base, a spring member comprising a coil spring, a spring insert, an adjustable rod, and a connector configured to attach a decoy to the spring insert.

### BRIEF DESCRIPTION OF THE DRAWINGS

FIG. 1 show as side view of a decoy mount.

FIG. 2 shows a top of a decoy mount.

FIG. 3 shows a detailed view cross-sectional view of a spring insert of a decoy mount.

FIG. 4 shows a detailed side view of a decoy mount.

FIGS. 5 and 6 show side views of a decoy mount.

FIGS. 7 and 8 show side views of a decoy mount having a second rod.

### DETAILED DESCRIPTION

While this invention may be embodied in many different forms, there are described in detail herein one or more specific embodiments. This description is an exemplification of the principles of the invention and is not intended to limit it to the particular embodiments illustrated.

For the purposes of this disclosure, like reference numerals in the figures shall refer to like features unless otherwise indicated.

A decoy mount, as herein disclosed, overcomes the aforementioned deficiencies of known decoy systems by enhancing decoy movement in low and no wind conditions. Additionally, the decoy mount is versatile enough to be used in higher wind situations. In particular, the decoy mount utilizes an adjustable rod and spring assembly permitting movement of the decoy in proportion to externally applied force (e.g., wind speed). Adjustment of the adjustable rod allows the decoy to be more (or less) sensitive to the wind speed; thus, the decoy mount can be configured to work in a variety of conditions.

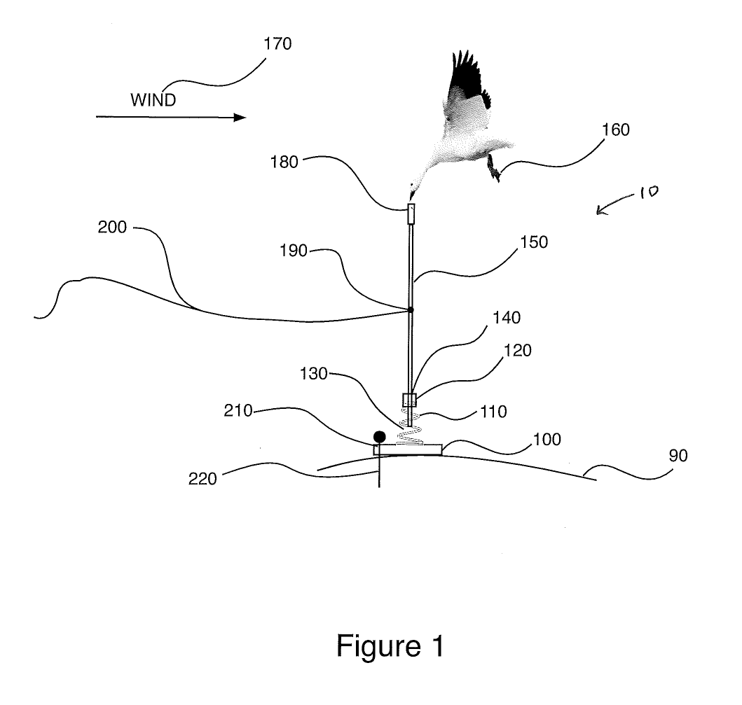

With regard to FIG. 1, a decoy mount 10 comprises a base 100, a spring member 110, and an adjustable rod 150. The base 100 can be anchored to the ground 90 for example via a spike or pin 220 in order to keep the decoy mount 10 in place. Further, in some embodiments, the base 100 has a mounting hole 210 through which the pin 220 can be directed.

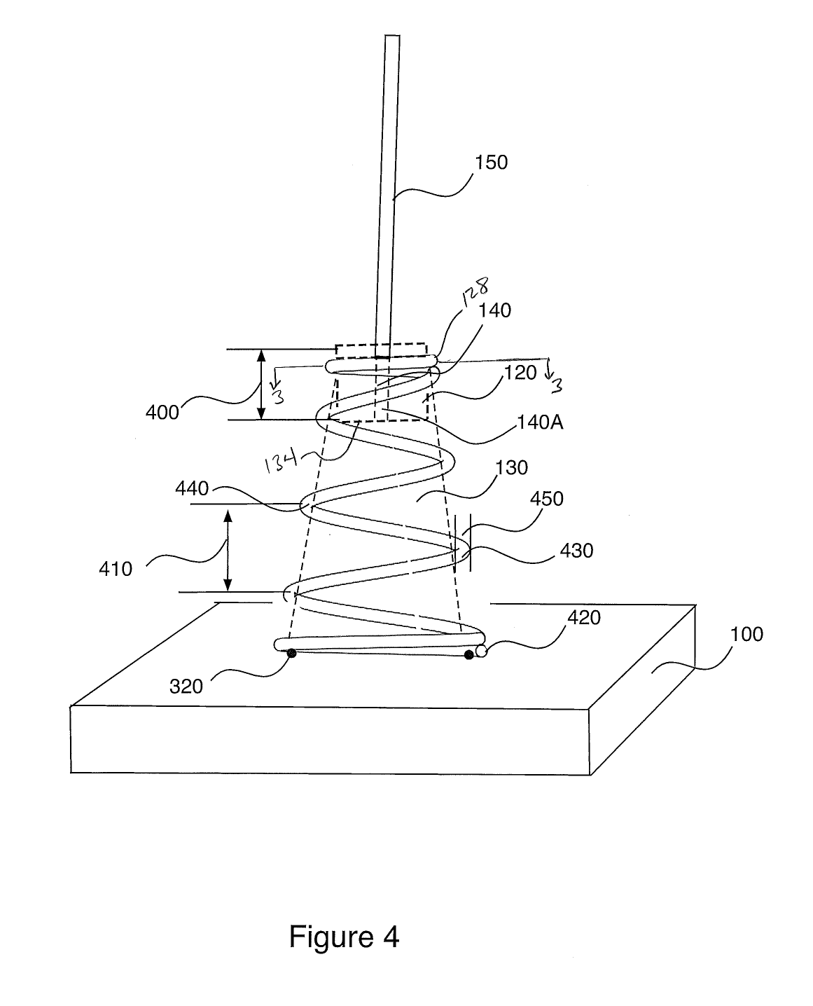

In some embodiments, the adjustable rod 150 is attached to the spring member 110 with an insert member 120. The insert member 120, in turn, is coupled to the spring member 110. In some embodiments, the insert member 120 is at least partially contained within a portion of the spring member 110. The spring member 110 defines a spring column 130 (FIG. 4), which can have a frustoconical, cylindrical, or any other suitable shape. The adjustable rod 150 is inserted through a channel 140 in the insert member 120. In this way, and as described in greater detail below, the adjustable rod 150 is selectively moveable within the channel 140. In some embodiments, the insert member 120 is formed from an elastomeric material, for example a rubber material.

In some embodiments, the decoy mount 10 further comprises a connector 180. The connector 180 can be of any suitable configuration for attaching the decoy 160 to the adjustable rod 150. Further, any suitable portion of the decoy 160 can be attached to the adjustable rod 150 via the connector 180. As shown in FIG. 1, for example, the connector 180 is attached to the beak of the decoy 160. It will be appreciated, however, that the connector 180 can be attached to the torso, wing, tail, feet, or any other suitable portion or portions of the decoy 160, depending upon the weight, size, center of mass, etc., of the decoy 160.

In some embodiments, the decoy mount 10 includes a pull cord 200 that is attached to the adjustable rod 150 at attach point 190. The attach point 190 can be located in any desirable location along the length of the adjustable rod 150 or can be located on the decoy 160, or in any other suitable location. Additionally, the pull cord 200 can be attached to the adjustable rod 150 at more than one location. The pull cord 200 can be utilized where the hunter desires to manually operate the decoy mount 10 to provide movement.

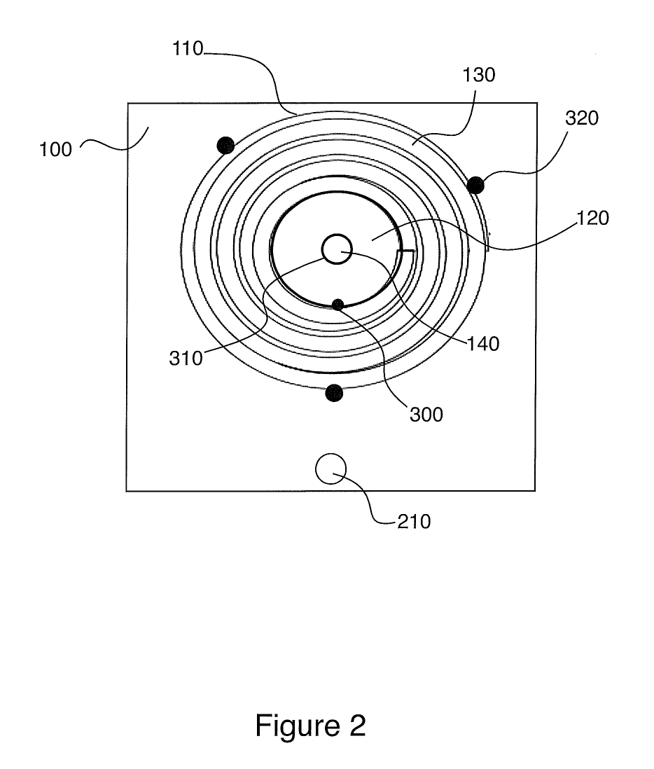

With regard to FIG. 2, the base 100 is shown in greater detail. The spring member 110 is fastened to the base via one or more fasteners 320. The fasteners 320 can be of any suitable variety and number. Examples include screws, nails, plastic straps, adhesive, etc.

As further illustrated in FIGS. 2 and 4, in some embodiments, the spring member 110 is a coil spring, for example, having a frusto-conical shape. The spring member 110 can also be a coil spring having a cylindrical shape or any other suitable shape.

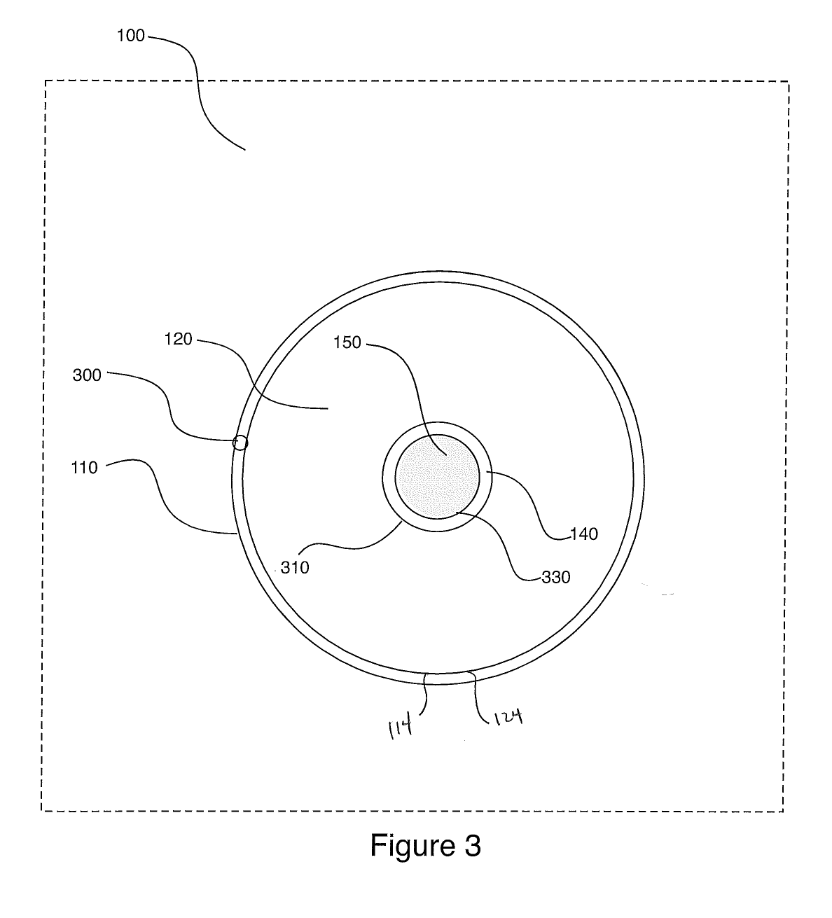

Turning to FIG. 3, a detailed cross-sectional view of the insert member 120 is shown. In some embodiments, the insert member 120 is attached to the spring member 110 via an insert fastener 300. In some embodiments, however, the insert member 120 is friction fit into a portion of the spring member 110. The insert member 120 has an outer circumference 114 and is contained within a portion of the spring member 110, for example an inner circumference 124 of an end portion 128 (FIG. 4) of the spring member 110. In some embodiments, the adjustable rod 150 is friction-fit into the channel 140 of the insert member 120. Such a friction-fit permits the user to adjust the adjustable rod 150 as desired yet prohibits movement of the adjustable rod 150 within the insert member 120 under normal operating conditions. The adjustable rod 150 can be held in place in any other suitable way, for example via clamp or wingnut. The adjustable rod 150 has an outer circumference 330 and the insert member 120 has an inner circumference 310 which is in contact with the outer circumference 330 of the adjustable rod 150.

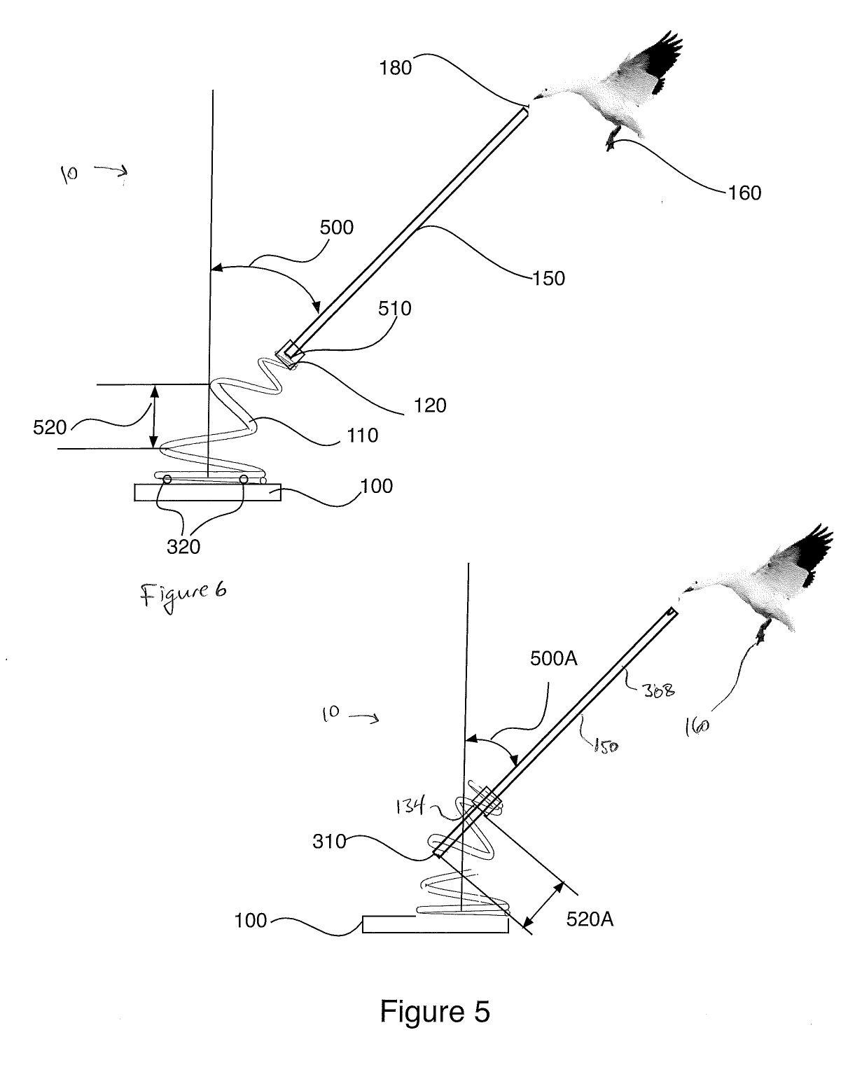

In order to provide life-like movement in limited wind conditions, and with regard to FIGS. 4-6, the adjustable rod 150 is movable within the channel 140. Adjustment of the adjustable rod 150 within the channel 140 permits more (or less) of the adjustable rod 150 to extend from the insert member 120, as shown via FIGS. 5 and 6. With further regard to FIG. 6, the adjustable rod 150 is extended to a further extent from the channel 140 than in FIG. 5. As a result, the decoy 160 moves an angle 500 for a given wind speed; in contrast, for the same wind speed, the decoy 160 shown in FIG. 5 moves an angle 500A, as the adjustable rod 150 in FIG. 5 is not extended to its full extent. Thus, where the length of adjustable rod 150 extending from spring member 110 is greater (as in FIG. 6), the weight of the decoy 160 (and adjustable rod 150) acts on a longer moment arm, permitting the decoy 160 to be more affected by wind than a shorter moment arm (as in FIG. 5).

Additionally, in some embodiments, the insert member 120 is longitudinally adjustable relative to the spring member 110 such that movement of the insert member 120 in the spring member 110 permits the user to further extend the adjustable rod 150 relative to the spring member 110. The insert member 120 can be moved to further tune the characteristics of the decoy mount 10. As shown in FIG. 6, for example, the insert member 120 is extended from the spring member 110 to a greater degree than the insert member 120 of FIG. 5. Further, it will be appreciated that the mass of the insert member 120 impacts the motion response of the decoy mount 10. In some embodiments, however, the spring insert 120 is rigidly attached to the spring member 110, for example by welding. The spring insert 120 can comprise any suitable material, for example a metal or plastic, and can be attached to the spring member 110 in any suitable way.

In some embodiments, the adjustable rod 150 extends from a distal end 134 of the insert member 120, as shown in FIG. 5, by a distance 520A. In such a configuration, a second section 310 of the adjustable rod 150 tends to counteract the motion of the first section 308 of the adjustable rod 150.

The configuration of the spring member 110 will also impact the performance characteristics of the decoy mount 10. In some embodiments, the spring member 110 has at least two spring coils 440, for example between two and 20 spring coils. With further regard to FIGS. 4 and 6, the distance 410 between adjacent spring coils 440 affects how the spring member 110 reacts in response to an input force (e.g., via the adjustable rod 150) (spring coils are also shown via reference numerals 420 and 430). For example, the spring member 110 can have a progressive spring rate; as shown in FIG. 6, some of the coils are separated by a greater distance (e.g., 520) than other spring coils. Additionally, the thickness 450 of the spring coils 430 affects the characteristics of the spring member 110. The spring member 110 can have a uniform thickness 450 throughout the spring member 110 or, in some embodiments, the thickness 450 can vary, as desired.

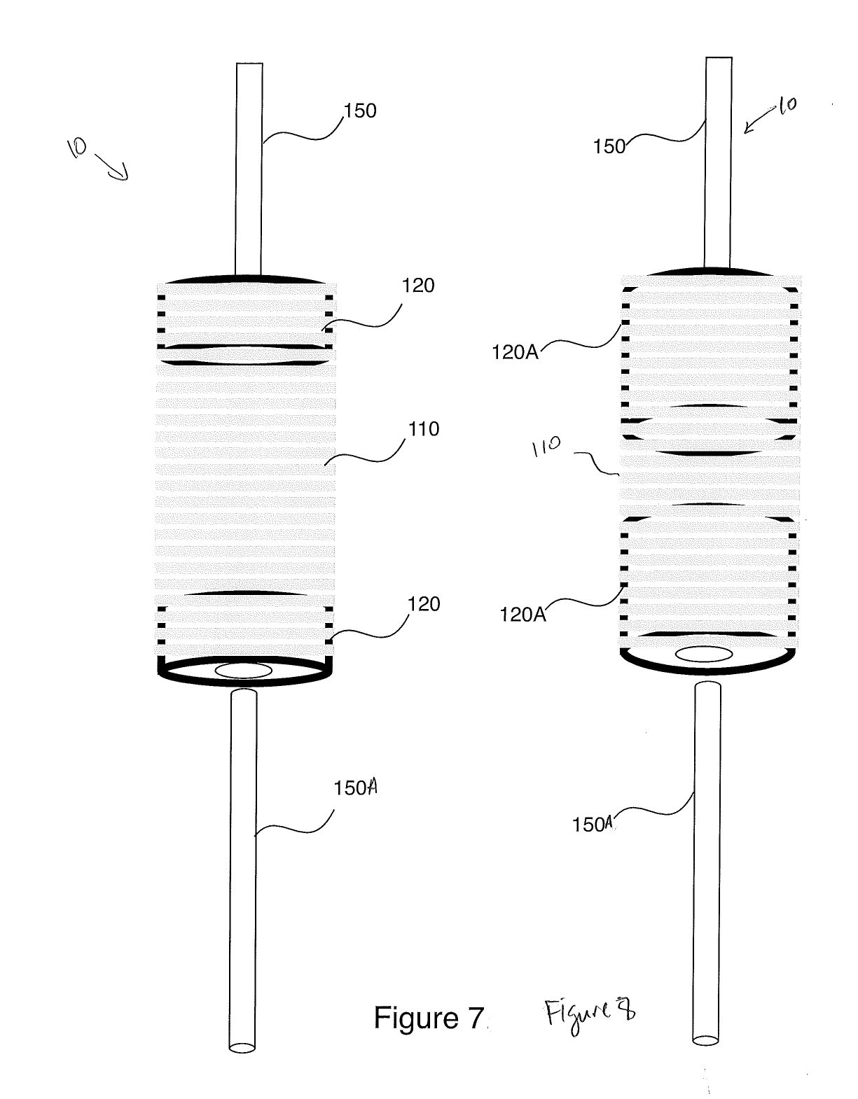

Turning to FIGS. 7 and 8, in some embodiments, the decoy mount 10 includes a second rod 150A, in addition to adjustable rod 150. The second rod 150A comprises a stake that can be inserted into the ground and can serve as the base of the decoy mount 10. As further shown in FIGS. 7 and 8, the decoy mount 10 includes two insert members 120 (120A in FIG. 8), which are inserted into or otherwise coupled to the spring member 110. The insert members 120, 120A can have any desirable length; the length of the insert members in FIG. 7 is shorter than the insert members of FIG. 8. Further, one of the two insert members 120 (or 120A in FIG. 8) can be longer than the other of the two insert members 120 (or 120A in FIG. 8). The length of the insert member 120, 120A, and the extent to which the insert member 120, 120A is inserted into the spring member 110, influences the characteristics of the decoy mount 10. Additionally, the extent to which the adjustable rod 150 and second rod 150A are inserted into the insert members 120, 120A influences the performance characteristics of the decoy mount 10. Thus, the user is able to tune the decoy mount 10 by adjusting the insert members, adjustable rod 150, and second rod 150A.

While the decoy mount 10 is discussed herein in the context of a waterfowl decoy, it can be used with other types of decoys, including crow, pigeon, turkey, and game species like deer, antelope, coyote, etc. Additionally, the disclosed apparatus can also be used outside of the hunting arena, for example recreationally for attracting or distracting birds (e.g., distracting seagulls from landing on a dock) or agriculturally (e.g., scarecrow in the garden).

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the invention. Those skilled in the art may recognize other equivalents to the specific embodiment described herein which equivalents are intended to be encompassed by the claims attached hereto.

What is claimed is:

1. A decoy mount comprising:
a base, a spring member, an adjustable rod, a spring insert, and a decoy, the spring member being attached to the base, the spring insert being coupled to the spring member, and the adjustable rod being slidable within the spring insert, wherein the decoy is attached to an end of the adjustable rod.

2. The decoy mount of claim 1, wherein the spring member comprises at least two coils.

3. The decoy mount of claim 1, wherein the spring insert has an outer circumference and the spring member has a distal end, the distal end having an inner circumference, the outer circumference of the spring insert being disposed within the inner circumference of the spring member.

4. The decoy mount of claim 3, wherein the spring member has a longitude and the spring insert is movable along the longitude.

5. The decoy mount of claim 3, wherein the spring insert is rigidly attached to the spring member.

6. The decoy mount of claim 1, wherein the spring insert has a channel and the adjustable rod is disposed within the channel.

7. The decoy mount of claim 6, wherein the spring insert is frictionally engaged to the channel.

8. The decoy mount of claim 1, wherein the base comprises a second rod.

9. The decoy mount of claim 8 further comprising a plurality of spring inserts.

10. The decoy mount of claim 9, wherein the plurality of spring inserts includes a first spring insert and a second spring insert, the first spring insert disposed within a first end of the spring member and the second spring insert disposed within a second end of the spring member.

11. The decoy mount of claim 10, wherein the second rod extends from the second spring insert and the adjustable rod extends from the first spring insert.

12. The decoy mount of claim 1, wherein the spring member defines a spring column.

13. The decoy mount of claim 12, wherein the spring column has a frustoconical shape.

14. The decoy mount of claim 1, further comprising a pull cord attached to the adjustable rod.

15. A decoy mount comprising:
A base, a spring member attached to the base, an adjustable rod, and a decoy attached to the adjustable rod, the adjustable rod being longitudinally adjustable with respect to the spring member, wherein the spring member comprises a coil spring.

16. The decoy mount of claim 15, wherein the base comprises a second rod.

17. The decoy mount of claim 15 further comprising a spring insert disposed within a portion of the spring member, the adjustable rod being moveable with respect to the spring insert.

18. A decoy mount kit comprising:
a base;
a spring member comprising a coil spring;
a spring insert;
an adjustable rod; and
a connector configured to attach a decoy to the spring insert.

19. The decoy mount kit of claim 18 further comprising a decoy.

20. The decoy mount kit of claim 18 further comprising a pin configured to secure the base to the ground.
